(19) United States
(12) Patent Application Publication
(10) Pub. No.: US 2006/0291234 A1
(43) Pub. Date: Dec. 28, 2006

(54) Vehicle having an auxiliary illuminating function

(76) Inventor: Charlie Fan Chiang, Chung He City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/151,621

(22) Filed: Jun. 13, 2005

(51) Int. Cl. F21S 8/10

(52) U.S. Cl. 362/545

(57) ABSTRACT

A vehicle includes a main body, at least one light mounted on the main body, and an auxiliary illuminating device mounted on the main body and enclosed around the light to provide an auxiliary illuminating effect. Thus, the light emitting members are started to light constantly when the lights are inoperative to provide an auxiliary illuminating and warning effect, thereby protecting the user's safety, and the light emitting members are also started to light constantly when the lights are normal.

### BACKGROUND OF THE INVENTION

1. Field of the Invention

The present invention relates to a vehicle, and more particularly to a wheeled vehicle, such as a car, a bus, a motorcycle, a bicycle or the like.

2. Description of the Related Art

A conventional vehicle, such as a car, in accordance with the prior art shown in FIG. 7 comprises a main body 5, and two headlights 50 mounted on the main body 5. However, each of the two headlights 50 is easily worn out during a long-term utilization, so that an emergency condition easily happens when one of the two headlights 50 is inoperative, thereby causing danger to the driver.

### SUMMARY OF THE INVENTION

The primary objective of the present invention is to provide a vehicle having an auxiliary illuminating function.

Another objective of the present invention is to provide a vehicle, wherein the light emitting members are started to light constantly when the lights are inoperative to provide an auxiliary illuminating and warning effect, thereby protecting the user's safety, and the light emitting members are also started to light constantly when the lights are normal.

A further objective of the present invention is to provide a vehicle, wherein when one light is inoperative and the other light is normal, the light rays of the light emitting members enclosed around the normal light are transmitted to the light emitting members enclosed around the inoperative light by the optical fiber bundle to enhance the auxiliary illuminating effect.

Further benefits and advantages of the present invention will become apparent after a careful reading of the detailed description with appropriate reference to the accompanying drawings.

### BRIEF DESCRIPTION OF THE DRAWINGS

FIG. 1 is a front plan view of a vehicle in accordance with the preferred embodiment of the present invention;

FIG. 2 is a locally enlarged view of the vehicle as shown in FIG. 1;

FIG. 3 is a front plan view of a vehicle in accordance with another preferred embodiment of the present invention;

FIG. 4 is a locally enlarged view of the vehicle as shown in FIG. 3;

FIG. 5 is a rear plan view of a vehicle in accordance with another preferred embodiment of the present invention;

FIG. 6 is a partially side plan view of a vehicle in accordance with another preferred embodiment of the present invention; and

FIG. 7 is a front plan view of a conventional vehicle in accordance with the prior art.

### DETAILED DESCRIPTION OF THE INVENTION

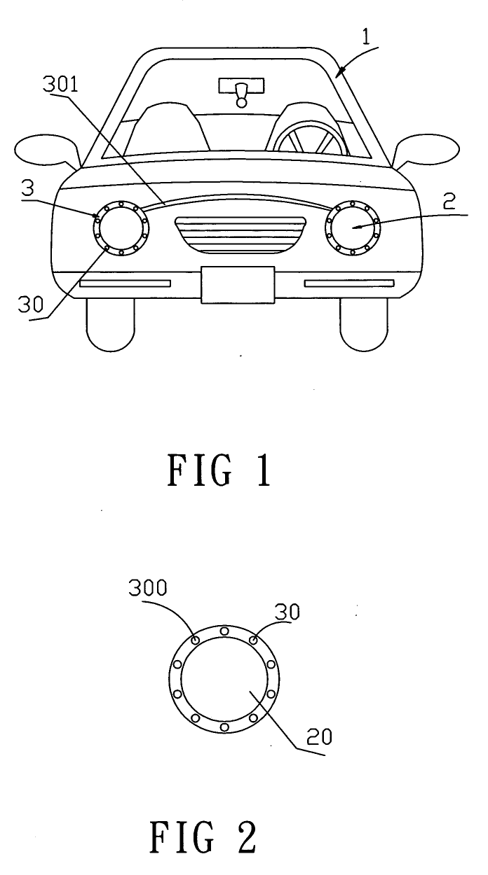

Referring to the drawings and initially to FIGS. 1 and 2, a vehicle in accordance with the preferred embodiment of the present invention comprises a main body 1, at least one light 2 mounted on the main body 1, and an auxiliary illuminating device 3 mounted on the main body 1 and enclosed around the light 2 to provide an auxiliary illuminating effect.

In the preferred embodiment of the present invention, the vehicle comprises two lights 2 mounted on the main body 1, and the auxiliary illuminating device 3 is enclosed around each of the two lights 2 to provide an auxiliary illuminating effect. Preferably, the main body 1 is a car, and each of the two lights 2 is mounted on a front side of the main body 1.

The auxiliary illuminating device 3 includes a plurality of light emitting members 30 enclosed around each of the two lights 2. The light emitting members 30 are enclosed around a periphery of each of the two lights 2 and are arranged in a loop shape to match a shape of each of the two lights 2. Preferably, each of the light emitting members 30 includes a light emitting diode 300.

Each of the two lights 2 is provided with a reflective plate 20, and each of the light emitting members 30 is directed toward the reflective plate 20 of each of the two lights 2 so that light rays emitted from the light emitting members 30 are reflected outward by the reflective plate 20 of each of the two lights 2. Alternatively, each of the light emitting members 30 is directed outward relative to each of the two lights 2 so that the light rays of the light emitting members 30 are directly emitted outward.

Thus, the light emitting members 30 are started to light constantly when the lights 2 are inoperative to provide an auxiliary illuminating and warning effect, thereby protecting the user's safety. Alternatively, the light emitting members 30 are also started to light constantly when the lights 2 are normal.

The auxiliary illuminating device 3 further includes an optical fiber bundle 301 mounted between the two lights 2 and connected to the light emitting members 30 enclosed around each of the two lights 2 to connect the light emitting members 30 enclosed around each of the two lights 2. Thus, when one of the two lights 2 is inoperative and the other one of the two lights 2 is normal, the light rays of the light emitting members 30 enclosed around the normal light 2 are transmitted to the light emitting members 30 enclosed around the inoperative light 2 by the optical fiber bundle 301 to enhance the auxiliary illuminating effect.

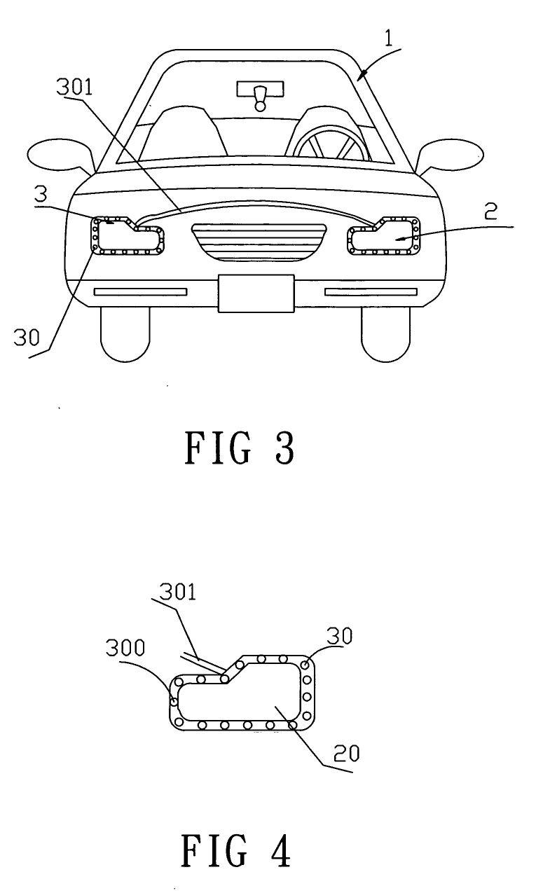

Referring to FIGS. 3 and 4, each of the two lights 2 has a different shape, and the light emitting members 30 are arranged in a loop shape to match the shape of each of the two lights 2.

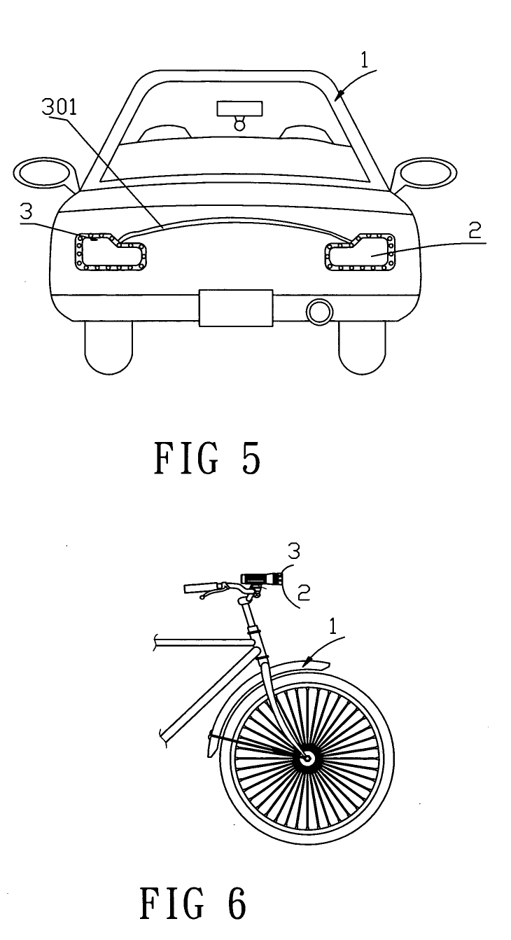

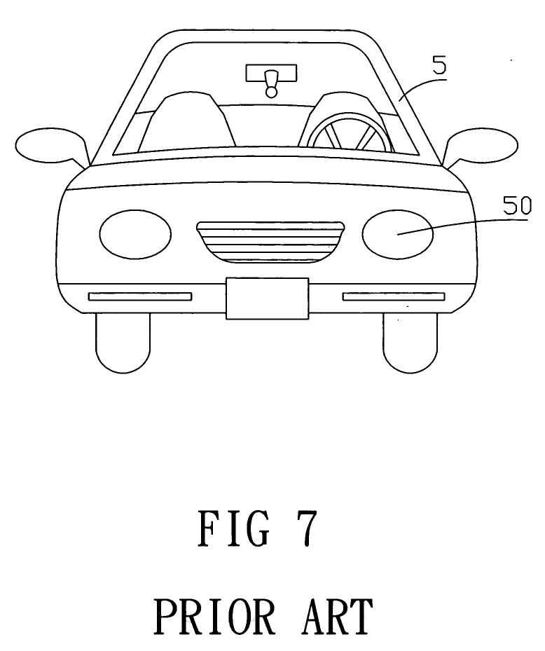

Referring to FIG. 5, each of the two lights 2 is mounted on a rear side of the main body 1.

Referring to FIG. 6, the main body 1 is a bicycle, and the light 2 is mounted on the front side of the main body 1.

Accordingly, the light emitting members are started to light constantly when the lights are inoperative to provide an auxiliary illuminating and warning effect, thereby protecting the user's safety, and the light emitting members are also started to light constantly when the lights are normal. In addition, when one light is inoperative and the other light is normal, the light rays of the light emitting members enclosed around the normal light are transmitted to the light emitting members enclosed around the inoperative light by the optical fiber bundle to enhance the auxiliary illuminating effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A vehicle, comprising:
a main body;
at least one light mounted on the main body;
an auxiliary illuminating device mounted on the main body and enclosed around the light to provide an auxiliary illuminating effect.

2. The vehicle in accordance with claim 1, wherein the vehicle comprises two lights mounted on the main body, and the auxiliary illuminating device is enclosed around each of the two lights.

3. The vehicle in accordance with claim 2, wherein the auxiliary illuminating device includes a plurality of light emitting members enclosed around each of the two lights.

4. The vehicle in accordance with claim 3, wherein the light emitting members are enclosed around a periphery of each of the two lights.

5. The vehicle in accordance with claim 3, wherein the light emitting members are arranged in a loop shape to match a shape of each of the two lights.

6. The vehicle in accordance with claim 3, wherein each of the light emitting members includes a light emitting diode.

7. The vehicle in accordance with claim 3, wherein each of the two lights is provided with a reflective plate, and each of the light emitting members is directed toward the reflective plate of each of the two lights so that light rays emitted from the light emitting members are reflected outward by the reflective plate of each of the two lights.

8. The vehicle in accordance with claim 3, wherein each of the light emitting members is directed outward relative to each of the two lights so that the light rays of the light emitting members are directly emitted outward.

9. The vehicle in accordance with claim 3, wherein the light emitting members light when the lights are inoperative to provide an auxiliary illuminating and warning effect.

10. The vehicle in accordance with claim 3, wherein the auxiliary illuminating device further includes an optical fiber bundle mounted between the two lights and connected to the light emitting members enclosed around each of the two lights to connect the light emitting members enclosed around each of the two lights.

11. The vehicle in accordance with claim 10, wherein the when one of the two lights is inoperative and the other one of the two lights is normal, the light rays of the light emitting members enclosed around the normal light are transmitted to the light emitting members enclosed around the inoperative light by the optical fiber bundle to enhance the auxiliary illuminating effect.

12. The vehicle in accordance with claim 3, wherein each of the two lights has a different shape, and the light emitting members are arranged in a loop shape to match the shape of each of the two lights.

13. The vehicle in accordance with claim 2, wherein each of the two lights is mounted on a front side of the main body.

14. The vehicle in accordance with claim 2, wherein each of the two lights is mounted on a rear side of the main body.
